(19) United States
(12) Patent Application Publication
(10) Pub. No.: US 2015/0042022 A1
(43) Pub. Date: Feb. 12, 2015

(54) STRETCH BLOW MOLDING SYSTEM WITH A PROPORTIONAL PRE-BLOWING VALVE

(71) Applicant: Norgren AG, Balterswill (CH)

(72) Inventor: Othmar Rymann, Balterswil (CH)

(73) Assignee: Norgren AG, Balterswill (CH)

(21) Appl. No.: 14/384,571

(22) PCT Filed: Mar. 14, 2013
(86) PCT No.: PCT/EP2013/055280

§ 371 Date: Sep. 11, 2014

Related U.S. Application Data
(60) Provisional application No. 61/610,642, filed on Mar. 14, 2012.

(51) Int. Cl. B29C 49/08

(52) U.S. Cl. CPC B29C 49/08; B29K 2067/003
USPC 264/532; 425/535

(57) ABSTRACT

A stretch blow molding system (200) is provided. The stretch blow molding system (200) includes a cylinder (201) with a movable stretch rod (202). The stretch blow molding system (200) further includes a proportional pre -blowing valve (204) including a first fluid port (204a) in fluid communication with a first pressurized fluid source (244) at a first pressure and a second fluid port (204b) in fluid communication with the cylinder (201) and selectively in fluid communication with the first fluid port (204a). The stretch blow molding system (200) further comprises a blowing valve (214) including a first fluid port (214a) in fluid communication with a second pressurized fluid source (247) at a second pressure, higher than the first pressure, and a second fluid port (214b) in fluid communication with the cylinder (201) and selectively in fluid communication with the first fluid port (214a).

### TECHNICAL FIELD

The embodiments described below relate to, stretch blow molding, and more particularly, to a stretch blow molding system with a proportional pre-blowing valve.

### BACKGROUND OF THE INVENTION

Blow molding is a generally known process for molding a preform part into a desired product. The preform is in the general shape of a tube with an opening at one end for the introduction of pressurized gas, typically air; however, other gases may be used. One specific type of blow molding is stretch blow molding (SBM). In typical SBM applications, a valve block provides both low and high-pressure gas to expand the preform into a mold cavity. The mold cavity comprises the outer shape of the desired product. SBM can be used in a wide variety of applications; however, one of the most widely used applications is in the production of Polyethylene terephthalate (PET) products, such as drinking bottles. Typically, the SBM process uses a low-pressure fluid supply along with a stretch rod that is inserted into the preform to stretch the preform in a longitudinal direction and radially outward and then uses a high-pressure fluid supply to expand the preform into the mold cavity. The low-pressure fluid supply along with the stretch rod is typically referred to as a pre-blowing phase of the molding cycle. The high-pressure fluid supply that expands the preform into the mold cavity is typically referred to as the blowing phase of the molding cycle. The low-pressure and high-pressure fluid supplies can be controlled using blow-mold valves. The resulting product is generally hollow with an exterior shape conforming to the shape of the mold cavity. The gas in the preform is then exhausted through one or more exhaust valves. This process is repeated during each blow molding cycle.

FIG. 1a shows a prior art blow molding valve block assembly 100. The prior art blow molding valve block assembly 100 includes a valve block 102, a stretch rod 104, control chambers 106a-106d, operating chamber rings 108a-108d, valve pistons 110a-110d, and pilot valves 112. The stretch rod 104 extends vertically through the central chamber 101 and out the bottom of the valve block 102. The valve block 102 includes four sets of valves that are vertically stacked in the central chamber 101 and around the stretch rod 104. For example, the four sets of valves may correspond to a pre-blowing valve, a blowing valve, an air recovery valve, and an exhaust valve. As can be appreciated, a pilot air supply is provided by the pilot valves 112 in order to control the position of each valve piston 110a-110d. As can be seen, the valve pistons 110a and 110b are shown in the open position with the valve pistons 110c and 110d in the closed position. The valve block 102 also includes a number of inlet and outlet ports 114, 116, and 118. In use, the valve pistons are controlled using the various pilot valves 112 in order to direct the flow of pressurized gas through the valve block 102. In addition to the four valves shown, at least one additional valve or an electric motor is required to control the position of the stretch rod 104.

One of the more critical steps in the molding process occurs during the pre-blowing phase. During this phase, a pressure up to approximately 12 bar (174 psi) is provided to the preform while the stretch rod 104 simultaneously extends the preform in a longitudinal direction. The supply of air during the pre-blowing phase can be seen between times t₀-t₁ in FIG. 1b. During this pre-blowing phase, there is an attempt to substantially uniformly distribute the material of the preform along the longitudinal length prior to expansion of the preform against the mold cavity. Due to the relatively abrupt supply of air to the preform, uniform distribution of the material is not always possible. As can be seen, between times t₀ and t₁, the pressure rapidly increases without adequate control. As a result, manufacturers typically provide excess thickness to the preform in order to account for variations in the distribution of the preform during the molding cycle. The excess material allows even the thin areas to satisfy the minimum thickness requirements once the high pressure air is supplied during the blowing phase.

Once the pre-blowing phase is complete, the pre-blowing valve is closed and the blowing valve is opened, which provides the blowing pressure to the stretched preform. This phase can be seen between times t₁ and t₂ in FIG. 1b. Upon completion of the blowing phase, the blowing valve is closed and the air-recovery valve can be opened. This phase can be seen between times t₂ and t₃. During the air-recovery phase, a portion of the blowing pressure can be recovered for later use. For example, the blowing pressure may be reused for the next pre-blowing phase. Finally, between times t₃ and t₄, the exhaust valve is opened to exhaust the remaining pressure from the formed product.

In an attempt to reduce the problems associated with uneven material distribution, one prior art solution is to use a single proportional valve for providing the air to the preform. Such an approach is outlined in WO/2011/154326, which is assigned on its face to the present applicants. Proportional valves are generally known in the art and can operate to open a port of the valve at virtually any point between fully open and fully closed. Therefore, rather than simple on/off operation as in traditional valves, proportional valves are capable of maintaining an actuation state between fully on and fully off. Although the approach proposed by the '326 application provides adequate proportional control in some situations, the use of a single proportional valve for the pre-blowing and the blowing pressure has serious drawbacks.

As mentioned above, the pre-blowing pressure is typically around 1-12 bar (14.5 psi-174 psi). However, the blowing pressure typically reaches around 40 bar (580 psi). As those skilled in the art will generally understand, in order to use a single proportional valve, the valve must be able to accommodate the high flow rate/pressure of the blowing phase. This results in the proportional valve being oversized for the pre-blowing phase. For example, while the proportional valve would only need a nominal diameter of approximately 8 mm (0.3 in.) for the pre-blowing pressure, the proportional valve is required to have a nominal diameter of approximately 16-20 mm (0.6-0.8 in.) to accommodate the much higher blowing pressure and flow volume. The increased size of the proportional valve results in increased difficulty in controlling the pressure during the pre-blowing phase and excessive frictional losses as thicker and stronger seals are required to provide fluid-tight sealing for the 40 bar (580 psi) pressure. With the increased sealing friction along with the numerous partial openings during the pre-blowing phase, the large valves are subject to premature failure. Furthermore, with the increased valve size, accurate proportional control of the valve during the pre-blowing phase becomes difficult.

The present embodiments described below overcome these and other problems and an advance in the art is achieved. The embodiments described below provide a proportional pre-blowing valve and a separate blowing valve. In some embodiments, the blowing valve may be proportional as well; however, such a configuration is not necessary. The proportional pre-blowing valve can be controlled based on time or a stretch rod position, for example in order to accurately control the shape and thickness of the preform. The use of the proportional pre-blowing valve allows the preform to be made thinner resulting in a reduction of material costs.

### SUMMARY OF THE INVENTION

A stretch blow molding system is provided according to an embodiment. The stretch blow molding system comprises a cylinder including a movable stretch rod. According to an embodiment, the stretch blow molding system further comprises a proportional pre-blowing valve including a first fluid port in fluid communication with a first pressurized fluid source at a first pressure and a second fluid port in fluid communication with the cylinder and selectively in fluid communication with the first fluid port. According to an embodiment, the proportional stretch blow molding system further comprises a blowing valve including a first fluid port in fluid communication with a second pressurized fluid source at a second pressure and a second fluid port in fluid communication with the cylinder and selectively in fluid communication with the first fluid port.

A method for stretch blow molding a preform in a mold cavity coupled to a stretch blow molding system is provided according to an embodiment. The stretch blow molding system includes a cylinder, a piston movable within the cylinder and a stretch rod coupled to the piston. According to an embodiment, the method comprises a step of actuating a proportional pre-blowing valve from a neutral position towards a first actuated position to supply pre-blowing pressure to the preform. According to an embodiment, the method further comprises a step of moving the stretch rod out of the cylinder to stretch the preform in a longitudinal direction. According to an embodiment, the method further comprises a step of actuating a blowing valve to a first position to supply a blowing pressure to the preform.

### Aspects

According to an aspect, a stretch blow molding system comprises:

a cylinder including a movable stretch rod;

a proportional pre-blowing valve including a first fluid port in fluid communication with a first pressurized fluid source at a first pressure and a second fluid port in fluid communication with the cylinder and selectively in fluid communication with the first fluid port; and

a blowing valve including a first fluid port in fluid communication with a second pressurized fluid source at a second pressure and a second fluid port in fluid communication with the cylinder and selectively in fluid communication with the first fluid port.

Preferably, the proportional pre-blowing valve further comprises a third fluid port in fluid communication with an exhaust and selectively in fluid communication with the second fluid port of the proportional pre-blowing valve.

Preferably, the stretch blow molding system further comprises a check valve positioned between the second fluid port of the proportional pre-blowing valve and the cylinder.

Preferably, the stretch blow molding system further comprises a piston coupled to the movable stretch rod and separating the cylinder into a first fluid chamber and a second fluid chamber.

Preferably, the stretch blow molding system further comprises a stretch rod control valve including:

a first fluid port adapted to receive a pressurized fluid;

a second fluid port in fluid communication with the first fluid chamber and selectively in fluid communication with the first fluid port; and

a third fluid port in fluid communication with the second fluid chamber and selectively in fluid communication with the first fluid port.

Preferably, the stretch blow molding system further comprises a position sensor including a first portion coupled to the cylinder and a second portion coupled to the piston.

Preferably, the stretch blow molding system further comprises an air recovery valve including a first fluid port in fluid communication with an air recovery system and a second fluid port in fluid communication with the cylinder and selectively in fluid communication with the first fluid port.

Preferably, the stretch blow molding system further comprises an exhaust valve including a first fluid port in fluid communication with an exhaust and a second fluid port in fluid communication with the cylinder and selectively in fluid communication with the first fluid port.

Preferably, the stretch blow molding system further comprises an electric linear motor coupled to the stretch rod (202) and configured to control a stretch rod position.

According to another aspect, a method for stretch blow molding a preform in a mold cavity coupled to a stretch blow molding system including a cylinder, a piston movable within the cylinder and a stretch rod coupled to the piston comprises steps of:

actuating a proportional pre-blowing valve from a neutral position towards a first actuated position to supply pre-blowing pressure to the preform;

moving the stretch rod out of the cylinder to stretch the preform in a longitudinal direction; and

actuating a blowing valve to a first position to supply a blowing pressure to the preform.

Preferably, the steps of actuating the proportional pre-blowing valve and moving the stretch rod occur substantially simultaneously.

Preferably, the actuation position of the proportional pre-blowing valve is based on a stretch rod position.

Preferably, the pre-blowing pressure is lower than the blowing pressure.

Preferably, the method further comprises a step of actuating an air recovery valve to recover a portion of the pressure supplied to the preform.

Preferably, the method further comprises a step of actuating an exhaust valve to exhaust the pressure supplied to the preform.

### BRIEF DESCRIPTION OF THE DRAWINGS

FIG. 1a shows a prior art blow molding valve block assembly.

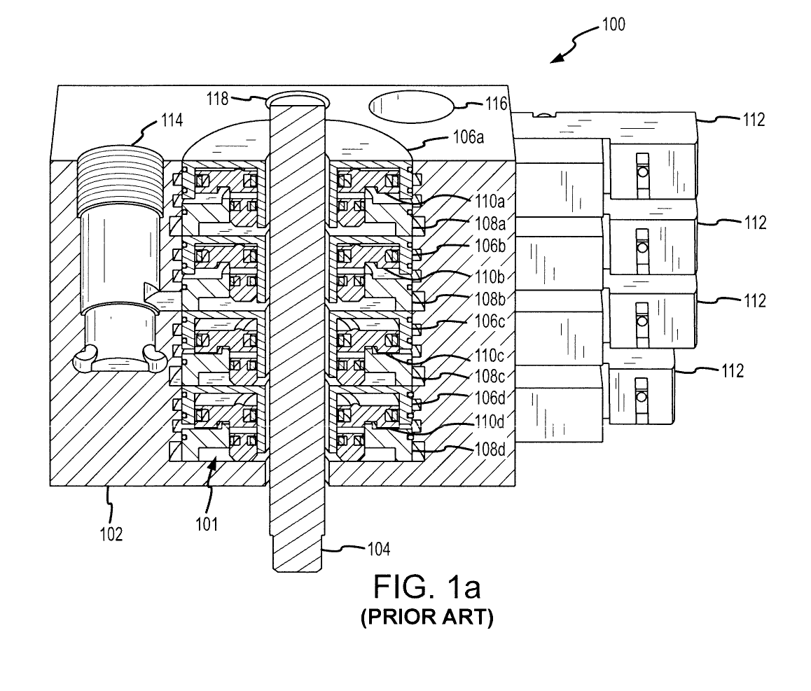

FIG. 1b shows a pressure versus time profile for a typical blowing operation according to the prior art.

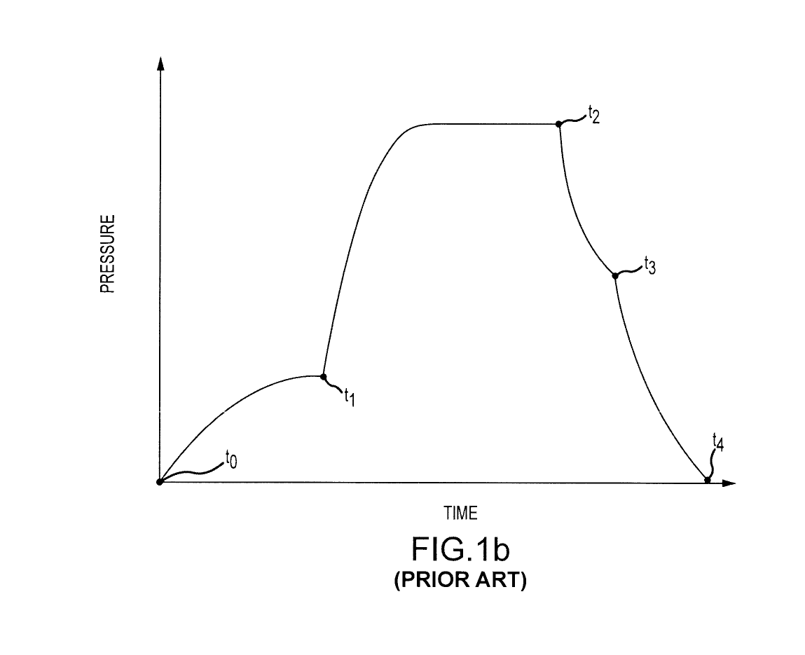

FIG. 2 shows a stretch blow molding system according to an embodiment.

FIG. 3 shows a stretch blow molding system according to another embodiment.

FIG. 4 shows a pressure versus time profile for a blowing operation using a proportional pre-blowing valve according to an embodiment.

### DETAILED DESCRIPTION OF THE INVENTION

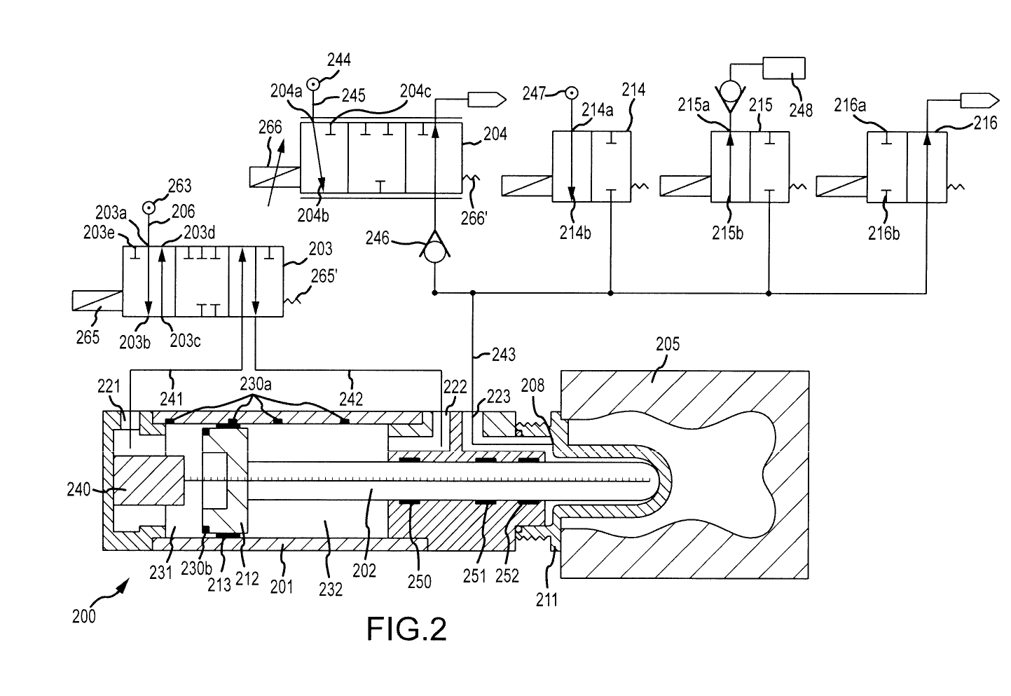

FIGS. 2-4 and the following description depict specific examples to teach those skilled in the art how to make and use the best mode of embodiments of a blow molding system. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the blow molding system. As a result, the embodiments described below are not limited to the specific examples described below, but only by the claims and their equivalents.

FIG. 2 shows a cross-sectional view of the proportional stretch blow molding system 200 according to an embodiment. The proportional stretch blow molding system 200 can include a cylinder 201, a stretch rod 202, a stretch rod control valve 203, and a plurality of blow-mold valves 204, 214, 215, 216. While valves 203, 204, 214, 215, and 216 are shown schematically and remote from the cylinder 201, in some embodiments, the valves may be coupled to the cylinder 201. Further, it should be appreciated that while electrical cabling is not shown in FIG. 2 in order to simplify the complexity of the drawing, the valves 203, 204, 214, 215, 216 can be connected to appropriate electronics to control actuation of the valves. Alternatively, the valves may be controlled mechanically or with a pilot pressure, for example. Therefore, the valves should not be limited to electronic control. According to an embodiment, the cylinder 201 is adapted to form a substantially fluid-tight seal with a mold cavity 205. According to another embodiment, the cylinder 201 is adapted to form a substantially fluid-tight seal with the preform 211, which is positioned partially in the mold cavity 205 and in fluid communication with the blow-mold valves 204, 214, 215, 216 in FIG. 2. A portion of the preform 211 is shown outside of the mold cavity 205 and coupled to the cylinder 201. In other embodiments, the cylinder 201 may be coupled to the mold cavity 205 and the entire preform 211 may be positioned within the mold cavity 205. It should be appreciated that the mold cavity 205 may be provided as a separate component by an end user, for example, and may not form part of the proportional stretch blow molding system 200. Therefore, the proportional stretch blow molding system 200 may be adapted to couple numerous different types of mold cavities 205 and performs 211.

According to the embodiment provided in FIG. 2, the stretch rod control valve 203 is in fluid communication with a first port 221 and a second port 222 formed in the cylinder 201. According to an embodiment, a piston 212 separates the cylinder 201 into a first chamber 231 and a second chamber 232. According to an embodiment, the piston 212 is coupled to the stretch rod 202. The piston 212 and stretch rod 202 may be movable within the cylinder 201. The piston 212 may include a sealing member 213, which can provide a substantially fluid-tight seal between the piston 212 and the cylinder 201. Further, the cylinder 201 can include additional sealing members 250, 251, 252, which form substantially fluid-tight seals with the stretch rod 202. The sealing members 213 and 250-252 can prevent pressurized fluid from passing between chambers 231, 232 or from the second chamber 232 to the mold cavity 205. According to an embodiment, the first port 221 is in fluid communication with the first chamber 231 and the second port 222 is in fluid communication with the second chamber 232. According to an embodiment, when pressurized fluid is provided to the first port 221, the first chamber 231 is pressurized thereby actuating the piston 212 and thus, the stretch rod 202 in a first direction. Conversely, when pressurized fluid is provided to the second port 222, the second chamber 232 is pressurized, which actuates the piston 212 and thus, the stretch rod 202 in a second direction, substantially opposite the first direction.

Also provided in FIG. 2, is a position sensor 230, which comprises a first sensor portion 230a coupled to the cylinder 201 and a second sensor portion 230b coupled to the piston 302. Although not shown in FIG. 2, the first sensor portion 230a may be in electrical communication with the stretch rod control valve 203 via a cable (not shown). According to one embodiment, the first portion of the position sensor 230 may comprise one or more magnetic sensors 230a while the second portion comprises a magnet 230b. One example of a position sensor that may be used with the present embodiment is disclosed in U.S. Pat. No. 7,263,781, which is assigned to the applicants of the present application. However, it should be appreciated that other position sensors may certainly be utilized with the present embodiment without departing from the scope of the embodiment.

According to an embodiment, the stretch rod control valve 203 can comprise a proportional valve. However, the stretch rod control valve 203 does not have to comprise a proportional valve and other types of valves may be used. In the embodiment provided in FIG. 2, the stretch rod control valve 203 comprises a 5/3-way proportional valve. The stretch rod control valve 203 may comprise a 5/3-way spool valve, for example. According to an embodiment, the stretch rod control valve 203 comprises a solenoid-actuated spool valve. A spring 265′ or other biasing member may be provided to de-actuate the valve 203 or bring the valve 203 to a default position. In other embodiments, a second solenoid (not shown) may be provided. According to an embodiment, in a de-actuated position, the stretch rod control valve 203 is closed. According to an embodiment, in the de-actuated position, pressurized fluid is not provided to or exhausted from the first or second chambers 231, 232.

According to an embodiment, a solenoid 265 may be used to open the stretch rod control valve 203 towards one or more actuated positions. Further, in embodiments where the stretch rod control valve 203 comprises a proportional valve, the solenoid 265 may be used to actuate the valve 203 to positions between a de-actuated position and a fully actuated position based on the set point signal provided to the solenoid 265. As mentioned briefly above, the set point signal may be provided by a processing system (not shown) according to the desired operating parameters. According to an embodiment, when the solenoid 265 actuates the stretch rod control valve 203 to a first actuated position, pressurized fluid is provided from a first port 203a to a second port 203b. In the embodiment shown, the first port 203a is adapted to receive a pressurized fluid. For example, the first port 203a is shown in fluid communication with the pressurized fluid source 263 while the second port 203b is in fluid communication with the first port 221 formed in the cylinder 201 via fluid pathway 241. The first port 203a is selectively in fluid communication with the second port 203b when the stretch rod control valve 203 is opened towards the first actuated position. Further, pressurized fluid can be exhausted from the third fluid port 203c to the fourth fluid port 203d. Therefore, as the stretch rod control valve 203 is actuated towards the first actuated position, pressurized fluid is supplied from the pressurized fluid source 263 to the first chamber 331 and exhausted from the second chamber 232. It should be appreciated that when the stretch rod control valve 203 is partially opened and between the de-actuated position and the first actuated position, the fluid communication path between the first port 203a and the second port 203b is only partially opened. Thus, the pressure provided to the first port 203a of the stretch rod control valve 203 from the pressurized fluid source 263 and delivered to the second port 230b of the stretch rod control valve 203 is limited. Additionally, prior to fully reaching the first actuated position, the fluid communication path between the third port 203c and the fourth port 203d is not fully opened and therefore, the fluid exhausted from the second chamber 232 is limited. Advantageously, if only a small movement of the stretch rod 202 is desired, the stretch rod control valve 203 can be actuated to a position between the de-actuated position and the first actuated position and only partially opened.

According to an embodiment, when the stretch rod control valve 203 is actuated and opened towards a second actuated position, the first port 203a is brought into fluid communication with the third port 203c and the second port 203b is brought into fluid communication with the fifth port 203e, which comprises an exhaust. Therefore, when the stretch rod control valve is opened towards the second actuated position, the stretch rod control valve 203 provides pressurized fluid to the second chamber 232 and exhausts the first chamber 231 to move the piston 202 and thus, the stretch rod 202 in a second longitudinal direction. It should be appreciated that less than the full pressure provided to the first port 203a is delivered to the third port 203c prior to the stretch rod control valve 203 fully reaching the second actuated position.

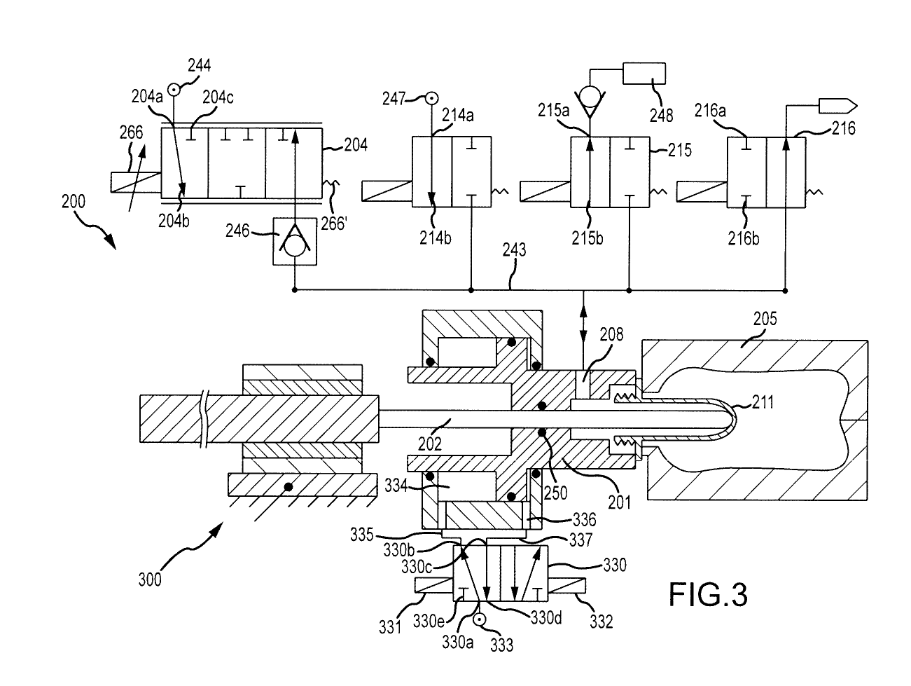

FIG. 3 shows a cross-sectional view of the proportional stretch blow molding system 200 according to another embodiment. In the embodiment shown in FIG. 3, the stretch rod control valve 203 is replaced with an electric linear motor 300. Electric linear motors are generally known in the art such as provided by LinMot®. The particular motor used should in no way limit the scope of the present embodiment. According to an embodiment, the electric linear motor 300 can supply the position and speed information to the processing system (not shown). Therefore, the position sensor 230 can be omitted in some embodiments using the electric linear motor.

According to the embodiment shown in FIG. 3, an additional valve 330 is provided. The valve 330 can control the positioning of cylinder 201 with respect to the mold cavity 205. The valve 330 is shown as being controlled with two solenoids 331, 332; however, the valve 330 may be controlled using other means. According to an embodiment, the valve 330 comprises a 5/2-way valve; however, other types of valves may be utilized without departing from the scope of the present embodiment.

According to an embodiment, when the valve 330 is in a first position, a first fluid port 330a is brought into fluid communication with a second fluid port 330b. According to an embodiment, the first fluid port 330a is in fluid communication with a pressurized fluid source 333 while the second fluid port 330b is in fluid communication with a fluid chamber 334 via the fluid pathway 335. Simultaneously, when the valve 330 is in the first position, a third fluid port 330c is brought into fluid communication with a fourth fluid port 330d. The third fluid port 330c is in fluid communication with a second fluid chamber 336 via a fluid pathway 337. Therefore, when the valve 330 is in the first position, the fluid chamber 334 is pressurized while the second fluid chamber 336 is exhausted.

According to an embodiment, when the valve 330 is in a second position, the first fluid port 330a is brought into fluid communication with the third fluid port 330c while the second fluid port 330b is brought into fluid communication with a fifth fluid port 330e. Therefore, in the second position, the fluid chamber 336 is pressurized while the fluid chamber 334 is exhausted. Consequently, based on the actuation of the valve 330, the cylinder 201 can be brought towards or away from the mold cavity 205.

Referring now to FIGS. 2 & 3, there are the various blow-mold valves 204, 214, 215, and 216. According to an embodiment, the blow-mold valve 204 comprises a proportional pre-blowing valve, which is in fluid communication with a pre-blowing pressure supply 244 via a fluid pathway 245. According to an embodiment, the pre-blowing pressure supply 244 may be at a first pressure. According to an embodiment, the first pressure is approximately 12 bar (174 psi), for example; however, other pressures may be used. While the pre-blowing pressure supply 244 is typically air, other gases may be used depending on the particular application. Because the pre-blowing valve 204 comprises a proportional valve, it may be actuated at substantially any position between fully opened and fully closed. In some embodiments, the proportional pre-blowing valve 204 can comprise a proportional spool valve. One example proportional spool valve is the “VP60 Proportional Spool Valve” sold by the present applicants. According to an embodiment, the proportional pre-blowing valve 204 may comprise a glandless spool valve. Glandless valves do not require separate seals between the spool and the sleeve. Consequently, less friction is experienced during actuation compared to valves with separate seals. For example, the VP60 Proportional Spool valve comprises a Teflon coated spool that slides within a sleeve. The Teflon spool provides the necessary sealing function without the need for separate seals. It should be appreciated that other proportional valves may be used and the present embodiment should in no way be limited to the particular examples provided.

According to the embodiment shown, the proportional pre-blowing valve 204 comprises a solenoid-actuated proportional valve with a solenoid 266; however, in other embodiments, the proportional pre-blowing valve 204 could be fluidly or mechanically actuated. The particular method used to actuate the proportional pre-blowing valve 204 should in no way limit the scope of the present embodiment. However, whatever actuation method is chosen should be able to proportionally actuate the valve, i.e., actuate the valve between fully actuated positions. In the embodiment shown, a spring 266′ or other biasing member is provided to bias the proportional pre-blowing valve 204 to a de-actuated or neutral position. However, in other embodiments, a second solenoid (not shown) could be provided. According to the embodiment shown, the proportional pre-blowing valve 204 comprises a 3/3-way proportional spool valve. It should be understood that the proportional pre-blowing valve 204 is not limited to a 3/3-way valve, but rather other valves may be utilized such as a 3/2-way, a 2/2-way, etc.

According to an embodiment, in a neutral position, all of the ports of the proportional pre-blowing valve 204 are closed. Upon actuating the solenoid 266, the proportional pre-blowing valve 204 begins actuating towards a first actuated position.

As the proportional pre-blowing valve 204 is being actuated towards the first actuated position, the first port 204a is brought into fluid communication with the second port 204b. When the first port 204a is in fluid communication with the second port 204b, the pressurized fluid source 244 is in fluid communication with the fluid pathway 243, which leads to the preform 211 via a third port 223 formed in the cylinder 201 and the opening 208 between the stretch rod 202 and the preform 211. As can be appreciated, while the proportional pre-blowing valve 204 may be fully opened, the proportional control of the valve 204 allows the valve to be actuated to a position between the neutral position and the full first actuated position. When the proportional pre-blowing valve 204 is between fully actuated positions, the rate at which the pressurized fluid is provided from the pressurized fluid source 244 to the preform 211 is reduced. Consequently, the pressure within the preform 211 can be more accurately controlled and adjusted.

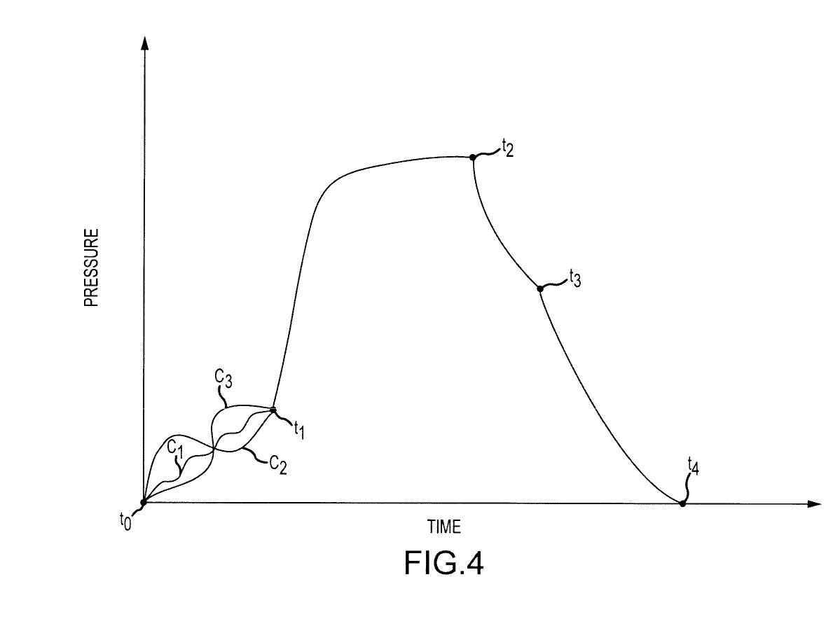

As can be appreciated, the proportional pre-blowing valve 204 can be used to pressurize the preform 211 to a predetermined pressure while the stretch rod 202 extends in the longitudinal direction using the valve 203. The use of the proportional pre-blowing valve 204 instead of a typical on/off valve, such as the valves 214-216, allows the pressure supplied to the preform 211 to be more accurately controlled. In one example, the actuation of the proportional pre-blowing valve 204 can be controlled based on a stretch rod position as determined by the position sensor 230 or by the electric linear motor 300. According to another embodiment, the actuation of the proportional pre-blowing valve 204 can be controlled based on an actuation time. For example, the proportional pre-blowing valve can be actuated to various positions for predetermined lengths of time. An example pressure curve is shown in FIG. 4. As shown, the pressure can be adjusted during the pre-blowing phase, which is represented between times t₀ and t₁. As can be seen by curve c₁, in one embodiment, the pressure supplied to the preform 211 during the pre-blowing phase can be delivered in a step-wise function. The stepped delivery is made possible by the proportional control of the proportional pre-blowing valve 204. The stepped delivery of the pre-blowing pressure to the preform 211 can provide a more consistent distribution and expansion of the preform as the stretch rod 202 extends and the pre-blowing pressure is provided. Other pressure curves are shown by curves c₂ and c₃. The improved material distribution of the preform 211 allows the preform 211 to be supplied with less material while maintaining the desired thickness of the end product.

According to an embodiment, the pre-blowing phase ends after a predetermined amount of time or once the pressure in the preform 211 reaches a threshold pressure. Upon the end of the pre-blowing phase, the proportional pre-blowing valve 204 can be actuated back to the neutral position. According to another embodiment, the proportional pre-blowing valve 204 can be actuated to a second position whereby the second port 204b is opened to the third port 204c (exhaust). According to an embodiment, if the proportional pre-blowing valve 204 is opened to exhaust, a check valve 246 can prevent air from exhausting from the preform 211 or portions of the fluid pathway 243 downstream from the check valve 246. In the embodiment shown in FIG. 2, the check valve 246 automatically prevents fluid from flowing from the fluid pathway 243 back to the valve 204. However, in the embodiment shown in FIG. 3, the check valve 246 comprises a controllable check valve that can be opened upon receiving a signal from a processing system (not shown). In other embodiments that do not have the check valve 246, the proportional pre-blowing valve 204 can be actuated back to the neutral position at the end of the pre-blowing phase. Therefore, it should be appreciated that the check valve 246 may be omitted in some embodiments.

According to an embodiment, after the pre-blowing phase, the system 200 enters the blowing phase. During the blowing phase, the blowing valve 214 can be actuated from a first position to a second position. According to an embodiment, the blowing valve 214 is a typical on/off valve without proportional control. Consequently, the blowing valve 214 cannot generally be actuated to positions between the first and second position. Once actuated to the second position, the first fluid port 214a is in fluid communication with the second fluid port 214b. According to an embodiment, the first port 214a can be in fluid communication with a blowing pressure supply 247. The blowing pressure supply 247 may be at a second pressure. According to an embodiment, the second pressure is higher than the first pressure. According to an embodiment, the second, blowing pressure, can be approximately 40 bar (580 psi), for example. However, the particular blowing pressure used will depend on the particular application and should in no way limit the scope of the present embodiment. While the blowing pressure is typically air, other gases may be used depending on the particular application. As the blowing valve 214 is actuated to the second position, the blowing pressure is supplied to the stretched preform. This increase in pressure during the blowing phase can be seen in FIG. 4 between times t₁ and t₂, for example. As discussed above, during the blowing phase, the stretched preform is expanded against the mold cavity 205 and shaped into the final product.

It should be appreciated that while a single blowing valve 214 is provided, more than one blowing valve may be used. For example, if two blowing valves were used, a first blowing valve may be used to raise the pressure from the pre-blowing pressure to approximately 20 bar (290 psi) while the second blowing valve could raise the pressure in the preform from 20 bar (290 psi) to 40 bar (580 psi). Consequently, those skilled in the art will readily recognize that the present embodiment is not limited to one blowing valve 214.

According to an embodiment, at the end of the blowing phase, the one or more blowing valves can be closed. During the next phase of operation, an optional air recovery valve 215 can be actuated from a first position to a second position. In the second position, the first fluid port 215a is in fluid communication with the second fluid port 215b of the air recovery valve 215. Upon being actuated to the second position, a portion of the air in the formed product can be sent to an air recovery system 248. In some embodiments, the air recovery system 248 may be in fluid communication with the pre-blowing pressure supply 244, for example. Therefore, the pre-blowing pressure supply 244 may not require a separate fluid source. According to an embodiment, the air recovery phase is depicted in FIG. 4 between times t₂ and t₃. As can be appreciated, in embodiments where more than one blowing valve is provided, more than one air recovery valve may be used.

Once the air recovery phase is complete, the air recovery valve 215 can be closed. At the end of the air recovery phase, the exhaust valve 216 can be actuated from a first position to a second position to exhaust the remaining pressure to atmosphere. In the second position, a first fluid port 216a is in fluid communication with a second fluid port 216b. The exhaust phase is shown in FIG. 4 between time t₃ and time t₄. Although separate air recovery and exhaust valves are shown and described, it should be appreciated that in alternative embodiments, the blowing valve 214 may be configured to act as the exhaust valve and optionally as the air recovery valve. For example, the blowing valve 214 could comprise a 5/4-way valve that can be actuated to supply the blowing pressure, exhaust to the air recovery system 248, exhaust to atmosphere, and close all ports. Therefore, the present embodiment should not be limited to requiring a separate and distinct air recovery valve 215 and exhaust valve 216.

In use, the proportional stretch blow molding system 200 may be used to stretch blow mold a preform into a desired product by being coupled to the preform 211 and/or the mold cavity 205. Once a fluid tight seal is formed, the pre-blowing phase can begin. As discussed above, during the pre-blowing phase, the proportional pre-blowing valve 204 can be actuated towards a first position in order to supply a pre-blowing air supply to the cylinder 201 and thus, the preform 211. Although the proportional pre-blowing valve 204 may be fully actuated to the first position, in other embodiments, the proportional pre-blowing valve 204 may be actuated between a neutral or closed position and the first actuated position. By being actuated between a fully actuated position, the air supplied to the preform 211 is limited and can be provided to the preform 211 in a more controlled manner. For example, the air can be supplied in a stepped manner or in a gradual increasing manner.

According to an embodiment, the stretch rod 202 can also be extended from the cylinder 201 and into the preform 211 during the pre-blowing phase. In some embodiments, the actuation of the stretch rod 202 can occur substantially simultaneously with the actuation of the proportional pre-blowing valve 204. According to an embodiment, the stretch rod 202 can be extended into the preform 211 to stretch the preform 211 in a longitudinal direction by actuating the stretch rod control valve 203 to a first actuated position thereby pressurizing the first fluid chamber 231. As mentioned above, in some embodiments, the actuation of the proportional pre-blowing valve 204 may be based on a stretch rod position as determined by the position sensor 230.

At the end of the pre-blowing phase, the proportional pre-blowing valve 204 may be actuated back to the neutral position or actuated to a second actuated position to exhaust the air between the second port 204b and the check valve 246. Alternatively, the proportional pre-blowing valve 204 may simply remain in the first actuated position as the check valve 246 will prevent the higher blowing pressure from reaching the proportional pre-blowing valve 204.

According to an embodiment, once the pre-blowing phase completes, the blowing valve 214 can be actuated to supply the blowing pressure to the stretched preform. The blowing pressure can expand the preform against the cavity so the preform assumes the shape of the interior of the cavity 205. After the blowing pressure is supplied to the cylinder 201 and thus, the preform 211, the air recovery valve 215 or the exhaust valve 216 can be actuated to recover a portion of the air or exhaust the air to atmosphere.

The embodiments described above provide a proportional stretch blow molding system 200 that utilizes a proportional pre-blowing valve 204 along with a separate blowing valve 214. Additionally, an air recovery valve 215 and an exhaust valve 216 can be provided. The use of a proportional pre-blowing valve 204 allows greater control over the pre-blowing phase to provide improved material distribution of the preform 211 during the pre-blowing phase. Further, by providing a separate blowing valve 214 instead of combining the pre-blowing and blowing phases into a single valve, the pre-blowing valve can be made smaller. The reduced size of the pre-blowing valve 204 can improve fine control and reduce frictional losses due to seal wear as the required sealing pressure is substantially reduced. Additionally, the use of the relatively small proportional pre-blowing valve 204 provides a higher dynamic response.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other blow molding systems, and not just to the embodiments described above and shown in the accompanying figures. Accordingly, the scope of the embodiments described above should be determined from the following claims.

We claim:

1. A stretch blow molding system (200), comprising:
a cylinder (201) including a movable stretch rod (202);
a proportional pre-blowing valve (204) including a first fluid port (204a) in fluid communication with a first pressurized fluid source (244) at a first pressure and a second fluid port (204b) in fluid communication with the cylinder (201) and selectively in fluid communication with the first fluid port (204a); and
a blowing valve (214) including a first fluid port (214a) in fluid communication with a second pressurized fluid source (247) at a second pressure and a second fluid port (214b) in fluid communication with the cylinder (201) and selectively in fluid communication with the first fluid port (214a).

2. The stretch blow molding system (200) of claim 1, wherein the proportional pre-blowing valve (204) further comprises a third fluid port (204c) in fluid communication with an exhaust and selectively in fluid communication with the second fluid port (204b) of the proportional pre-blowing valve (204).

3. The stretch blow molding system (200) of claim 1, further comprising a check valve (246) positioned between the second fluid port (204b) of the proportional pre-blowing valve (204) and the cylinder (201).

4. The stretch blow molding system (200) of claim 1, further comprising a piston (212) coupled to the movable stretch rod (202) and separating the cylinder (201) into a first fluid chamber (231) and a second fluid chamber (232).

5. The stretch blow molding system (200) of claim 4, further comprising a stretch rod control valve (203) including:
a first fluid port (203a) adapted to receive a pressurized fluid;
a second fluid port (203b) in fluid communication with the first fluid chamber (231) and selectively in fluid communication with the first fluid port (203a); and
a third fluid port (203c) in fluid communication with the second fluid chamber (232) and selectively in fluid communication with the first fluid port (203a).

6. The stretch blow molding system (200) of claim 4, further comprising a position sensor (230) including a first portion (230a) coupled to the cylinder (201) and a second portion (230b) coupled to the piston (212).

7. The stretch blow molding system (200) of claim 1, further comprising an air recovery valve (215) including a first fluid port (215a) in fluid communication with an air recovery system (248) and a second fluid port (215b) in fluid communication with the cylinder (201) and selectively in fluid communication with the first fluid port (215a).

8. The stretch blow molding system (200) of claim 1, further comprising an exhaust valve (216) including a first fluid port (216a) in fluid communication with an exhaust and a second fluid port (216b) in fluid communication with the cylinder (201) and selectively in fluid communication with the first fluid port (216a).

9. The stretch blow molding system (200) of claim 1, further comprising an electric linear motor coupled to the stretch rod (202) and configured to control a stretch rod position.

10. A method for stretch blow molding a preform in a mold cavity coupled to a stretch blow molding system including a cylinder, a piston movable within the cylinder and a stretch rod coupled to the piston, comprising steps of:
actuating a proportional pre-blowing valve from a neutral position towards a first actuated position to supply pre-blowing pressure to the preform;
moving the stretch rod out of the cylinder to stretch the preform in a longitudinal direction; and
actuating a blowing valve to a first position to supply a blowing pressure to the preform.

11. The method of claim 10, wherein the steps of actuating the proportional pre-blowing valve and moving the stretch rod occur substantially simultaneously.

12. The method of claim 10, wherein the actuation position of the proportional pre-blowing valve is based on a stretch rod position.

13. The method of claim 10, wherein the pre-blowing pressure is lower than the blowing pressure.

14. The method of claim 10, further comprising a step of actuating an air recovery valve to recover a portion of the pressure supplied to the preform.

15. The method of claim 10, further comprising a step of actuating an exhaust valve to exhaust the pressure supplied to the preform.
